(19) United States
(12) Patent Application Publication
(10) Pub. No.: US 2025/0325441 A1
(43) Pub. Date: Oct. 23, 2025

(54) DEEPCDIVER Dildo

(71) Applicant: David Gary Strack, Simpsonville, SC (US)

(72) Inventor: David Gary Strack, Simpsonville, SC (US)

(21) Appl. No.: 18/643,707

(22) Filed: Apr. 23, 2024

(51) Int. Cl. A61H 19/00

(52) U.S. Cl. CPC A61H 19/44; A61H 19/50

(57) ABSTRACT

A sexual aid, specifically a dildo, consisting of a proximal end that is designed specifically so the proximal end is held in the mouth and the shaft and distal end closely represent a male penis used to enter/engage openings such as the vagina or anus for female or male sexual partners.

### CROSS-REFERENCE TO RELATED APPLICATION

Not Applicable

### STATEMENT OF FEDERALLY SPONSORED RESEARCH OR DEVELOPMENT

Not Applicable

### BACKGROUND ON THE INVENTION

This invention pertains to the field of adult sexual aids, specifically focusing on the innovation and development of dildos. Dildos are devices designed for personal sexual stimulation, categorized under U.S. Patent Class D21, which includes toys and sports goods. Typically shaped like a penis, dildos are used for insertion into body orifices such as the vagina or anus, and can also be utilized for clitoral stimulation and other erotic zones.

Traditionally, dildos have been designed to be manually held, attached via a harness, or secured to a surface with suction cups. This variety of use-cases reflects the industry's evolution from simple phallic objects to more complex designs that cater to diverse preferences and functionalities. The current market offers various types of dildos, including traditional hand-held models, harness-compatible versions, and those with suction bases for attachment to flat surfaces. These products are typically made from materials like silicone, glass, and latex, chosen for their durability and safety. Despite these innovations, there remains a notable gap in the provision of dildos designed for hands-free operation without the use of harnesses or fixed surfaces, catering to users who may prefer or require such functionality due to physical limitations or for the novelty of shared experiences.

The invention described herein introduces a novel design for a dildo specifically crafted to be comfortably held in the mouth. This design seeks to address the limitations found in current technologies by providing a practical option for users seeking hands-free engagement. Existing products often lack stability, comfort, or practical usability in such configurations. This proposed invention employs an ergonomic design and utilizes safe, durable materials suited for oral use, offering an innovative solution that enhances accessibility and broadens the usability of dildos for a more inclusive range of users. This approach not only enhances the functional utility of the dildo but also prioritizes user safety and comfort, significantly advancing the field of sexual aids.

### BRIEF SUMMARY OF THE INVENTION

This invention, consisting of a penis shaped cylindrical shaft with a proximal end and a distal end. This invention is designed specifically so the proximal end can be comfortably held in the mouth while the distal end is used to enter/engage openings such as the vagina or anus for female or male sexual partners.

### BRIEF DESCRIPTION OF VIEWS OF THE DRAWING

FIG. 1.1 is a drawing showing a top/dorsal view of the invention with the distal end closest to the top of the drawing and the proximal end at the bottom of the drawing. The proximal end shows the “snorkel-like” mouthpiece with bitewings designed for the user to be able to hold the invention in the mouth, being stabilized by clenching the teeth onto the bitewings. The shaft and distal end in this example closely represents the male penis. While this example does not clearly show any specific “texture”, the actual texture of the invention may vary from completely smooth to a more natural representation of a male penis. Textures for this invention may also be, but not limited to, any variety of textures that enhance sensual/sexual stimulation.

FIGS. 1.2 shows a head on view of the distal end of the invention that is meant to show that the invention closely resembles a male penis glans.

FIGS. 1.3 shows the underside of the distal end of the invention that is meant to show that the invention closely resembles a male penis glans.

FIG. 2.1 is a drawing showing a side view of the invention with the distal end closest to the top of the drawing and the proximal end at the bottom of the drawing. The proximal end shows the side view of the “snorkel-like” mouthpiece bitewing designed for the user to be able to hold the invention in the mouth, being stabilized by clenching the teeth onto the bitewings. The shaft and distal end in this example closely represents the male penis. The invention's shaft may be straight (See FIG. 2.2), but may also be curved (FIG. 2.1) to better represent the shape of the male penis.

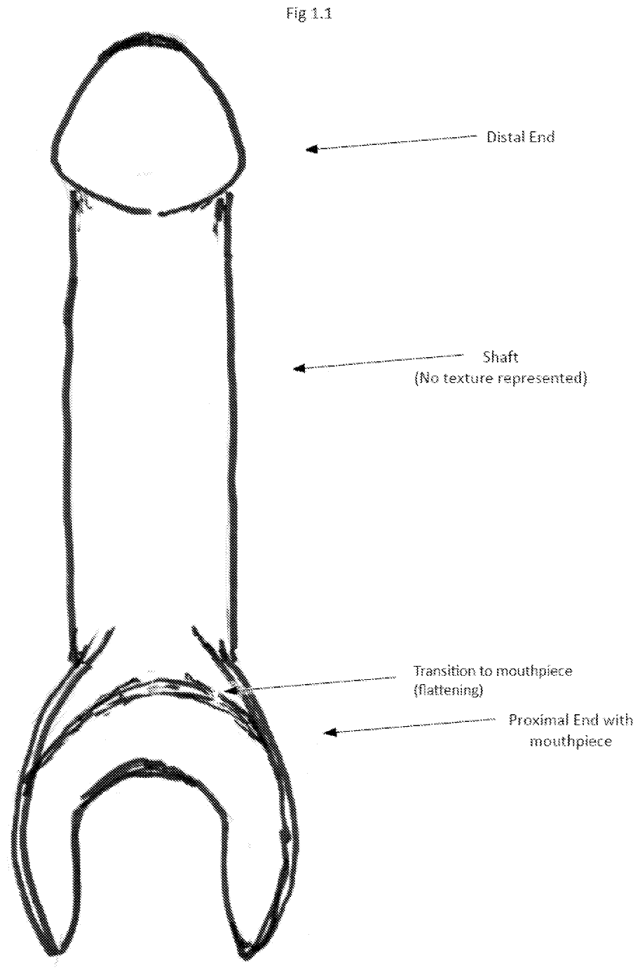

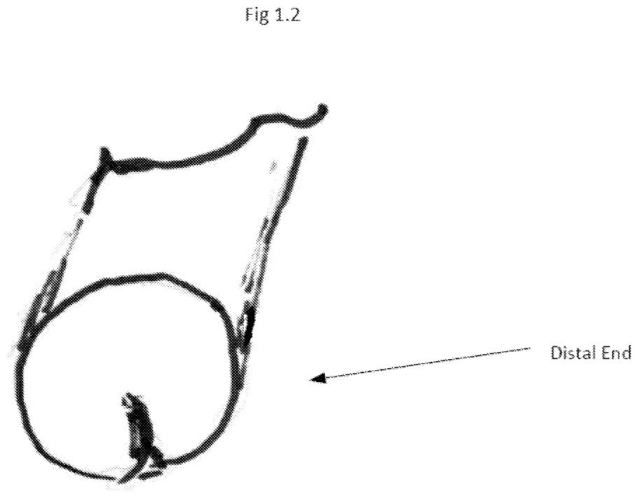

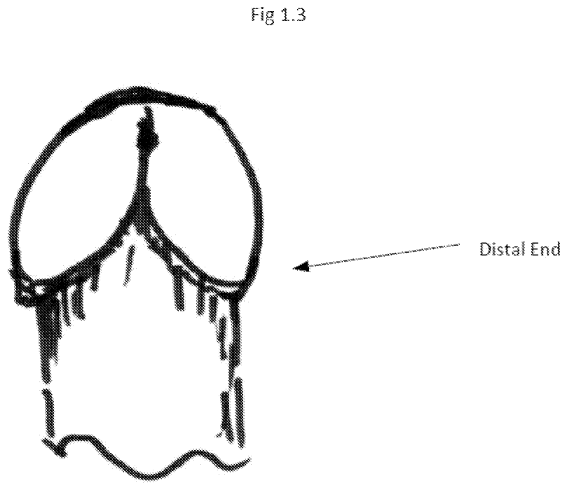

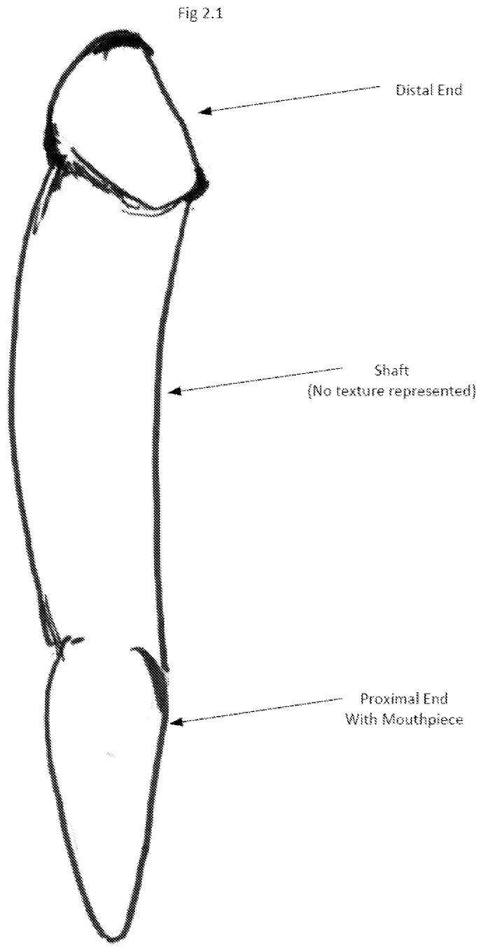

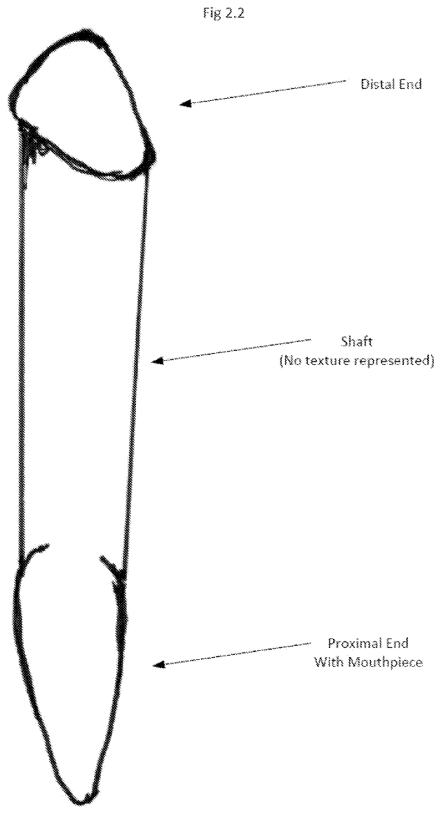

### DETAILED DESCRIPTION OF THE INVENTION

The invention, a dildo consisting of a penis shaped cylindrical shaft with a proximal end and a distal end. This invention is made of a latex-like non-porous, flexible food grade material that is ridged enough to be a functional dildo and still a soft enough material to be safely held by the mouth (teeth). The proximal end is designed similarly to a snorkel mouthpiece with bite wings so that the user can comfortably hold the invention in his/her mouth by clenching down on the bitewings with his or her teeth. The shaft and distal end are shaped and designed to closely represent a male penis and is used to enter/engage openings such as the vagina or anus for female or male sexual partners.

The length and girth of the invention may vary and is not limited. The texture of the invention may vary from completely smooth to a more natural representation of a male penis. Textures for this invention may also be, but not limited to, any variety of textures that enhance sensual/sexual stimulation. Additionally, the color and opaqueness of the invention is not limited to any color or opacity.

1. This invention is the only known dildo that has been designed specifically so that the proximal end can be held by the user's mouth with user's teeth.
